(19) United States
(12) Patent Application Publication
(10) Pub. No.: US 2025/0296275 A1
(43) Pub. Date: Sep. 25, 2025

(54) METHOD FOR REGULATION OF A CONTAINER PRODUCTION INSTALLATION

(71) Applicant: SIDEL PARTICIPATIONS, Octeville-sur-Mer (FR)

(72) Inventor: Pierrick PROTAIS, Octeville-Sur-Mer (FR)

(21) Appl. No.: 19/085,281

(22) Filed: Mar. 20, 2025

(30) Foreign Application Priority Data
Mar. 21, 2024 (FR) FR2402808

(51) Int. Cl. B29C 49/78; B29L 31/00

(52) U.S. Cl. CPC B29C 49/78; B29C 2049/78715; B29L 2031/7158

(57) ABSTRACT

Described is a method for producing thermoplastic material containers by blow-molding or stretch-blow-molding a hollow body previously heated in an oven and placed in a mold. The method includes a preliminary calibration step of: producing containers on the basis of first control parameters; measuring the wall thickness on extraction from the mold at two or more different heights; storing a reference thickness in a memory unit; modifying at least one control parameter; measuring the wall thickness at two or more different heights after the modification of each control parameter; storing the thicknesses; comparing said stored measured thicknesses with theoretical thicknesses that would have been obtained after modification of the control parameter(s) according to predetermined correction coefficients; and modifying the predetermined correction coefficients so that the thicknesses measured after modification of the control parameter(s) correspond to the theoretical thicknesses that would have been obtained with the aforementioned predetermined coefficients.

### CROSS-REFERENCE TO RELATED APPLICATIONS

This application claims the benefit of French Application No. FR2402808, filed Mar. 21, 2024, the entire contents of which is hereby incorporated herein by reference.

### TECHNICAL FIELD

The present invention concerns the field of the production of containers, such as bottles for example, by blowing or stretch-blowing hollow bodies made of thermoplastic material, such as polyethylene terephthalate (PET) for example. It has for object a method of by blow-molding or stretch-blow-molding containers from hollow bodies and an installation implementing such a method.

### BACKGROUND

In the field of the production of such containers it is well known for the containers to be manufactured on an installation comprising at least one heating unit and one shaping unit equipped with a succession of molds with an imprint in the design of the container to be formed and corresponding injection devices.

To be more precise, the production of these containers includes two main phases, namely a first phase of heating the hollow bodies, during which a succession of hollow bodies is heated in the heating unit to a reference temperature at which the hollow bodies are in a malleable state in which they can be formed to shape, and a second phase of shaping them during which the heated hollow bodies are each transferred into a mold of the blow-molding unit and a fluid under pressure is injected into each hollow body by the corresponding injection device or nozzle to confer on the preform the final shape of the container. The fluid under pressure is usually a gas such as air. Furthermore, shaping generally includes a stretching phase performed by a mobile stretching rod adapted to apply a stretching force to the bottom of a hollow body in a mold in order to stretch the preform along its axis, which contributes to maintaining the preform centered relative to the mold.

Furthermore, an installation for producing these containers generally comprises a control console from which numerous parameters can be adjusted manually by an operator to control the heating unit and/or the shaping unit. In the case of the heating unit, said parameters consist for example in the heating power, the heating time per zone by selecting whether each sender is on or off, the power of ventilation for transferring the heat applied to the external skin of the hollow body to the interior of said hollow body, the preferred heating temperature profile, etc. Where the shaping unit is concerned, said parameters consist for example of the pre-blowing pressure, the start time of pre-blowing, the pre-blowing flowrate, the stretching speed, the blowing pressure, etc.

The production method necessitates numerous preliminary tests before a container judged to conform is obtained, that is to say a container that complies with all of the quality criteria defined beforehand by a specification. The operation is complicated and takes a long time because it is essential to adjust each of the parameters of the installation and the method in order to guarantee that the container is conform. Furthermore, this preliminary step must be carried out for each container format and/or for each change of preform and/or for each change of material reference. The format of a container can notably be defined by the height and/or the shape and/or the volume thereof.

Tuning the production method and setting the parameters of the associated installation therefore necessitate the presence of an operator having a good knowledge of the installation, the method and the designs of hollow bodies liable to be fed into the installation in order to obtain a container shaped to the required format. This tuning also takes a long time, which directly impacts the production volume of the line.

The container obtained will thereafter be evaluated to determine if it satisfies the criteria or not throughout the production phase. For example, one quality criterion for judging the conformity of a container can be the distribution of the material along the height of the container for a particular format. It is known that one of the parameters of the production method that impacts this criterion is the heat treatment of the hollow bodies in the heating unit.

If this material distribution criterion suffers drift and is no longer judged conform, the operator has to adjust various parameters in order to correct the defect during the heat treatment phase and/or during the shaping phase. Furthermore, the modifications made must not lead to the appearance of other defects or problems.

In this regard, in order to alleviate this drawback, there has already been conceived a method of regulation of the heating parameters of the oven, notably regulation of variations of the electrical power of the sources of radiation, as a function of the thickness of the wall of the container that is formed. This is notably the case in European patent EP1998950.

The document EP1998950 proposes a solution consisting in monitoring the material distribution criterion using thickness sensors situated one above the other. If this criterion is judged non-conform, the power of the heating lamp situated at the same height as a sensor will be modified accordingly. This does not concern the other lamps and their adjustment is not corrected. The heat treatment of the hollow body is therefore not completely controlled.

Furthermore, this modification of the heating parameters of the oven leads to modification of the heat treatment of the hollow body during production and therefore generates non-conformity of the container formed relative to the specification of the client. Furthermore, the non-conformity of the container formed loads the production costs and can necessitate shutting down the installation, further loading the production costs.

Also known is the document EP2352633 that describes a method and apparatus for blow-molding containers. A hollow body made of a thermoplastic material is first subjected to heat treatment in the zone of a heating line along a transport path. The preform is then formed into a container in a blow-molding mold by the effect of a blowing pressure. Once the container has been blow-molded, a wall thickness is measured at one vertical level at least of the container. A predefined value for the thickness of the wall is transmitted to a controller as a required value and the measured thickness of the wall is transmitted to the latter as the real value. The controller predefines the value of at least one parameter influencing the blow-molding process as a function of the difference between the required value and the real value. To be more precise, the controller predefines the value of at least one parameter influencing the supply of blow-molding gas. The value of the parameter is predefined on the basis of a model employed in the controller to simulate the blow-molding process.

All these solutions are inadequate because they do not enable the operator to optimize the heating phase directly and rapidly. The information available to them does not enable correction of the defect without preventing other problems occurring, for example at other levels of the height of the container. Furthermore, each process has specific parameters. Thus variation of the value of one parameter generates different thickness variations of the containers for each process so that, in the event of deviation of the bottle thickness, it is difficult to predict which variation of which parameter will make it possible to return to the container thickness target value.

### DISCLOSURE OF THE INVENTION

One of the objects of the invention is therefore to remedy these drawbacks by proposing a method enabling modification of the heat treatment of the hollow bodies and/or the shaping parameters of the containers as a function of each production process.

To this end, and in accordance with the invention, there is proposed a method for producing thermoplastic material containers by blow-molding or stretch-blow-molding a hollow body heated beforehand in an oven and then disposed in a mold consisting of two half-molds delimiting a molding cavity, said hollow body being blow-molded in the mold, possibly with a pre-blowing step, said steps of heating the hollow bodies, pre-blowing and blow-molding being controlled by a control unit on the basis of various so-called control parameters such as the heating temperature of the hollow bodies in the oven, the blowing pressure in the mold and/or the pre-blowing pressure and/or the pre-blowing flowrate and/or the speed of the stretching rod for example; which method is characterized in that it comprises a preliminary so-called calibration step that includes at least the following steps:
producing containers on the basis of first control parameters to produce so-called conform containers;
measuring the thickness of the wall of said containers on extraction from the mold, at two different heights at least, corresponding to the production of containers on the basis of said first control parameters, said measurement of the thickness corresponding to a reference thickness;
storing said reference thickness in a memory unit;
modifying at least one control parameter;
measuring the thickness of the wall of said containers on extraction from the mold, at two different heights at least, after modification of the or said control parameter(s);
storing the thicknesses of the wall of said containers on extraction from the mold for each modified control parameter in said memory unit;
comparing said stored measured thicknesses with the thicknesses obtained without modification of the parameter or said parameters;
determining a correction coefficient for a thickness at a particular height for each parameter, said correction coefficient procuring the thickness variation corresponding to the required thickness of the wall of the container at the particular height.

The preliminary calibration step preferably includes at least the following steps:
producing containers on the basis of first control parameters to produce so-called conform containers;
measuring the thickness of the wall of said containers on extraction from the mold, at two different heights at least, corresponding to the production of containers on the basis of said first control parameters, said measurement of the thickness corresponding to a reference thickness;
storing said reference thickness in a memory unit;
modifying at least one control parameter, said modification being based on a predetermined correction coefficient associated with said control parameter;
measuring the thickness of the wall of said containers on extraction from the mold, at two different heights at least, after modification of the or said control parameter(s);
storing the thicknesses of the wall of said containers on extraction from the mold for each modified control parameter in said memory unit;
comparing said stored measured thicknesses with the theoretical thicknesses that would have been obtained after modification of the or said parameter(s) in accordance with the predetermined correction coefficients;
modifying the predetermined correction coefficients so that the thicknesses measured after modification of the control parameter or parameters correspond to the theoretical thicknesses that would have been obtained with the foregoing predetermined coefficients.

It is clear that, for each process, on first starting up, the container shaping installation is started up in the production phase with a validated specific process after which each parameter of the process is slightly modified automatically and the resulting thicknesses are recorded. It is therefore possible to customize the algorithm controlling the installation process and therefore, in the event of deviation of one or more thicknesses, the algorithm can choose the optimum parameter or parameters to be modified and the value of correction coefficients associated with each control parameter to return to thicknesses within the specifications of the container production process.

After the aforementioned calibration step, the method includes at least the following steps:
a) measuring the thickness of the wall of said containers on extraction from the mold, at two different heights at least;
b) comparing the measurements of the thicknesses with particular set point values for each height of the containers;
c) if the difference of the measurements of the thicknesses from the particular set point values is above a particular threshold, modifying at least one of the control parameters, the or said modified control parameters and the associated correction coefficient(s) being selected from at least one of the control parameters procuring the variation of thickness of the wall of the containers most pertinent vis-à-vis the thickness difference measured during the calibration step and/or by calculating the theoretical effects of the variation for each parameter on the thicknesses, said theoretical effects of the variation for each parameter defining a theoretical thickness, then selecting the parameter or parameters inducing the smallest difference between the measured thickness values and the theoretical thickness values;
d) steps a) to c) are repeated until the differences of the measurements of the thicknesses from the particular set point values are below said particular threshold.

Step c) preferably comprises at least the following steps:
defining for each parameter an optimum reference coefficient chosen from reference coefficients assigned to each thickness zone of the wall of the containers;
storing the lower and upper limits and scales for each of said parameters;
calculating an adjustment of each parameter as a function of said optimum reference coefficient defined beforehand;
calculating theoretical corrections for each thickness zone as a function of the calculated adjustments and the scales;
calculating the theoretical thickness difference of the containers as a function of the theoretical corrections calculated for each thickness zone;
adding said calculated theoretical differences for each parameter; and
selecting at least one parameter having the lowest cumulative difference values.

Furthermore, before the step of selecting at least one parameter, the method includes a step of organizing the parameters into a hierarchy as a function of said calculated theoretical differences.

Said parameters are organized into a hierarchy in increasing order, from the lowest cumulative difference value to the highest cumulative difference value.

After the step of calculating the adjustments and before the step of calculating the theoretical corrections, the method preferably includes an additional step of recalculating the adjustments if the calculated adjustments are not within said limits.

Furthermore, said zero calculated theoretical corrections are excluded.

Moreover, it is the absolute values of the calculated theoretical differences that are added.

The step of selecting the parameter is preferably carried out after calculating a new mean value of the thicknesses for each zone and/or if the combination of the differences for each thickness zone has changed.

Furthermore, a new mean value of the thicknesses for each zone is calculated at a predetermined frequency.

The method according to the invention advantageously includes a step of modifying the predetermined correction coefficients of the algorithm so that the thicknesses measured after modification of the control parameter or parameters correspond to the theoretical thicknesses that would have been obtained using the foregoing predetermined coefficients.

In a first execution variant, during said calibration step the control parameters are modified one by one.

In a second execution variant, during said calibration step each control parameter is modified simultaneously with at least one other control parameter.

Furthermore, during said calibration step each control parameter is modified by a predetermined incremental or decremental value.

Another object of the invention concerns a computer program product comprising a sequence of instructions which, when the program is executed by a computer, causes the latter to execute the steps of the method according to the invention.

A third object of the invention concerns a data processing device comprising means for executing the steps of the method according to the invention.

A final object of the invention concerns a computer-readable storage medium containing instructions which, when they are executed by a computer, cause the latter to execute the steps of the method according to the invention.

### BRIEF DESCRIPTION OF THE DRAWINGS

Other advantages and features will emerge more clearly from the following non-limiting description by way of example of a single execution variant of the method according to the invention given with reference to the appended drawings, in which:

FIG. 1 is a schematic representation as seen from above of a shaping installation employing the method according to the invention,

FIG. 2 is a side view that represents a hollow body intended to be fed into the shaping installation from FIG. 1,

FIG. 3 is a schematic representation of the various steps of shaping a container on passing through the shaping unit from FIG. 1,

FIG. 4 is a view in cross section of the heat treatment unit for the hollow bodies of the shaping unit from FIG. 1,

FIG. 5 is a schematic representation of the step of measuring the thickness of the wall of the container formed at different heights,

FIG. 6 is a flowchart of various steps of the method for regulation of the container forming unit according to the invention,

FIG. 7 is a flowchart of the various calibration steps of the method of regulation of the container forming unit according to the invention.

### EMBODIMENT OF THE INVENTION

In the remainder of the description of the method according to the invention for producing thermoplastic material containers by blow-molding or stretch-blow-molding a hollow body, the same reference numbers denote the same elements. The various views are not necessarily drawn to scale.

In the remainder of the description elements having an identical structure or analogous functions will be denoted by the same reference numbers.

In the remainder of the description, there will be adopted in a non-limiting manner a longitudinal orientation directed in the direction of movement of the hollow body with the vertical and transverse orientations indicated by the trihedron “L,V,T” in the figures.

Hereinafter the term “holding member” means a member for holding or a member for supporting a hollow body that is adapted to transport the hollow body from one point to another.

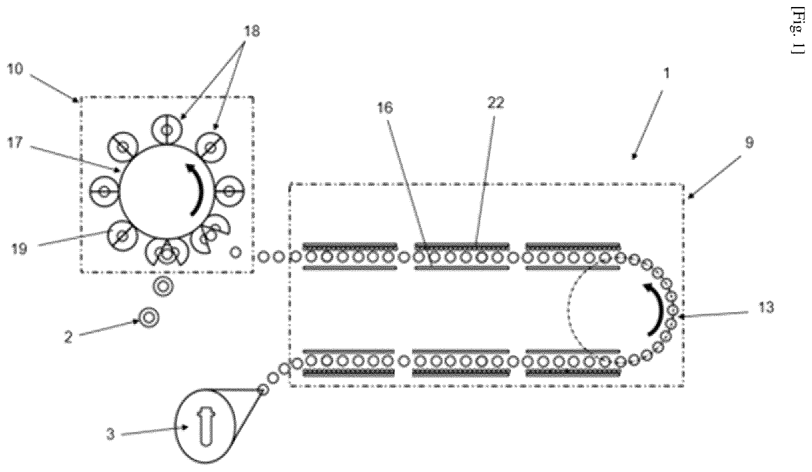

There has been schematically represented in FIG. 1 an installation 1 for shaping finished containers 2 made of a thermoplastic material, such as “PET” (polyethylene terephthalate), either recycled or not, or “PP” (polypropylene), starting with hollow bodies 3. The hollow bodies 3 are generally produced beforehand by injection molding. These hollow bodies 3 are generally cold when they are fed to the entry of the shaping installation 1.

In the remainder of the description the generic term “hollow body” will be used to denote interchangeably a preform, a container being formed or a finished container.

In the remainder of the description the hollow body 3 and the containers 2 are moved from upstream to downstream in the production installation along a circulation trajectory. The hollow bodies 3 are moved in single file along a heating trajectory by conveyor means described in detail hereinafter.

Here, in a non-limiting manner, the containers 2 are bottles. Here the thermoplastic material is for example polyethylene terephthalate, hereinafter referred to as “PET”.

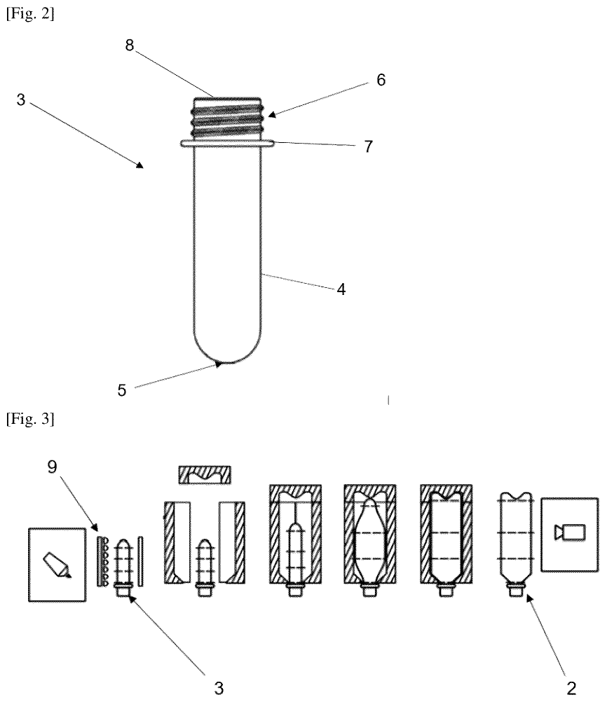

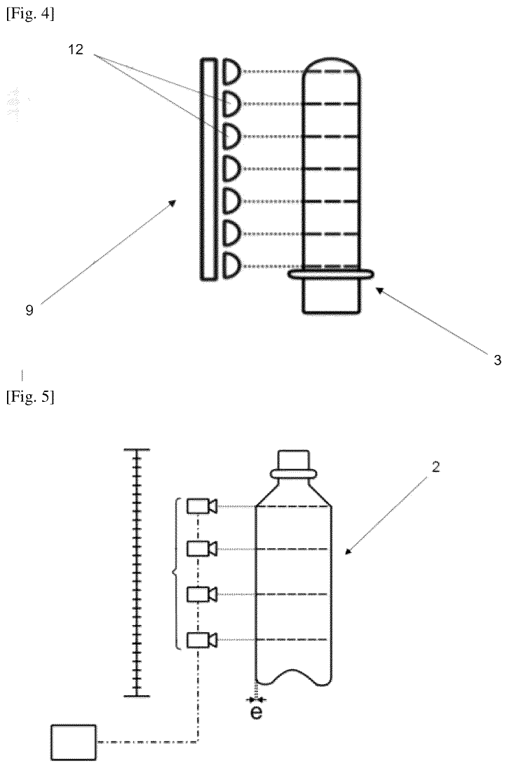

Referring to FIG. 2, each hollow body 3 has a main axis “X” represented as vertical in said FIG. 2. Each hollow body 3 has a substantially cylindrical body 4 with a tubular wall closed at one of its axial ends by a bottom 5 and open at its other end via a neck 6, also tubular. The neck 6 is delimited at the bottom by a flange 7 and at the top by an upper end edge 8 termed the mouth.

The neck 6 generally has its definitive shape whereas the body 4 of the hollow body 3 is intended to undergo a relatively large deformation during a shaping step to form the finished container 2.

Here the hollow bodies 3 are made of recycled or non-recycled “PET” or of “PP”, which is to say that the hollow body 3 is made by molding a single thermoplastic material of particular composition.

It goes without saying that without departing from the scope of the invention the hollow body 3 could be made of any other polymer such as polyethylene furanoate (PEF), polylactic acid (PLA), polyhydroxyalkanoates (PHA), high-density polyethylene (HDPE) or the like or a combination of the above polymers in a so-called multilayer form, with or without additive(s).

Among the characteristics liable to vary from one batch of hollow bodies 3 to another, note for example the thickness of the wall of the body 4 of the hollow body 3 or the level of absorption of infrared radiation by the thermoplastic material.

Referring to FIG. 1, the container production installation comprises at least one heat treatment unit 9 and one shaping unit 10.

The heat treatment unit 9, also referred to as the oven, enables heating of a succession of hollow bodies 3 to a reference temperature. The reference temperature is chosen so that the body 4 of each hollow body 3 on leaving the heat treatment unit 9 is in a malleable state enabling deformation of the body 4 of the heated hollow body 3 in order to form the container 2 in the shaping unit 10. The reference temperature is between the glass transition temperature and the crystallization temperature of the plastic material of the hollow body 3. In the case of PET, the reference temperature is for example close to 110°. The value of the reference temperature can vary as a function of the product with which the container 2 will be filled or as a function of the technique for filling the container. The reference temperature is therefore different for hot filling or for a carbonated product, for example.

In the embodiment represented in FIG. 1 the heat treatment unit 9 is a conveyor oven in which the hollow bodies 3 are supported to be exposed to a plurality of sources 12 radiating heat.

To this end, the heat treatment unit 9 comprises a means 13 for conveying the hollow bodies 3 through the heat treatment unit 9 along a heating trajectory extending between an entry and an exit of the heat treatment unit 9. Said conveyor means 13 usually comprises a succession of holding devices each adapted to support a hollow body 3 mounted on a chain and moving along the heating trajectory in the heat treatment unit 9.

Each holding device is for example adapted to receive a hollow body 3 by forcing the neck 6 onto a whirler, each whirler being for example mobile in rotation relative to the chain about a rotation axis coinciding with the main axis X of a hollow body 3 when the latter is supported by the whirler.

The heat treatment unit 9 also comprises a heating cavity that comprises two facing lateral walls, at least one of these walls being that which supports a plurality of sources 12 of radiation disposed one above the other and one alongside the other and facing the hollow bodies.

In other words, the heat treatment unit 9 comprises a plurality of sources 12 of radiation distributed along the heating trajectory and at a height substantially corresponding to the height of the hollow bodies so that the entire height of the body 4 of each hollow body 3 is exposed to the sources 12 of radiation on the trajectory of the hollow body in the heat treatment unit 9. By causing the hollow bodies 3 to turn about their main axis X the whirlers enable uniform exposure of all of the body 4 of the hollow bodies to the sources 12 of radiation. In this particular embodiment the sources 12 of radiation are distributed on only one side of this trajectory and a reflecting wall 16 is disposed on the other side of the heating trajectory to reflect heat toward the hollow bodies 3.

In another embodiment that is not represented and without departing from the scope of the invention the sources 12 of radiation can be distributed on either side of the heating trajectory.

It should also be noted that the sources 12 of radiation are if necessary arranged so as not to subject the neck 6 to the heat emitted by the sources 12 of radiation. Indeed, as previously indicated, only the body 4 of the hollow body 3 is shaped to produce the container 2. Consequently, the neck 6 must not be deformed during shaping and must not be heated. To prevent heating the neck 6, the heat treatment unit 9 can comprise a ventilation device positioned in line with the necks 6 of the hollow bodies 3 to evacuate heat that could be absorbed by said necks 6.

It is obvious that the sources 12 of radiation could without departing from the scope of the invention be replaced by any other heating means well known to the person skilled in the art such as VCEL diodes emitting monochromatic or pseudo-monochromatic electromagnetic radiation in the infrared band or microsources for example.

Once the hollow body 3 has been heat treated in the heat treatment unit 9 it is then transferred to the shaping unit 10 to be shaped therein.

Referring to FIG. 1, said unit 10 for shaping containers 2 from hollow bodies 3 consists of a shaping wheel 17 moving in rotation a plurality of blow-molding stations 18 from an entry to an exit, at which a succession of containers 2 have been formed from the hollow bodies 3, and are then extracted, as represented in FIG. 1. The rotation axis of the shaping wheel 17 is, for example, substantially parallel to the main axis X of the hollow bodies 3 when they are transported by the shaping wheel 17.

Each blowing station 18 comprises a mold 19 forming a molding cavity having the shape of the container 2 to be formed and adapted to receive a hollow body 3 so that the body 4 of the hollow bodies 3 extends in the molding cavity.

Note that the installation 1 also comprises one or more transfer wheels, not represented in the figures, at the entry of the heat treatment unit 9 and between the exit of the heat treatment unit 9 and the shaping unit, said transfer wheels usually comprising holding members for the first transfer wheel formed by holding clamps. Referring to FIG. 3, each hollow body 3 therefore undergoes different treatment steps as it moves along the production trajectory and notably a heating step in the heat treatment unit 9 followed by a shaping step in the shaping unit 10.

Generally speaking, a shaping installation 1 of this kind is able to produce finished containers 2 in different formats. To this end, the blow-molding stations 18 equipping the shaping unit 10 are fitted with interchangeable molds. It is therefore possible to modify the shape of the finished container produced.

Depending on the selected format of the finished container, the installation 1 will be fed with hollow bodies 3 having appropriate intrinsic characteristics.

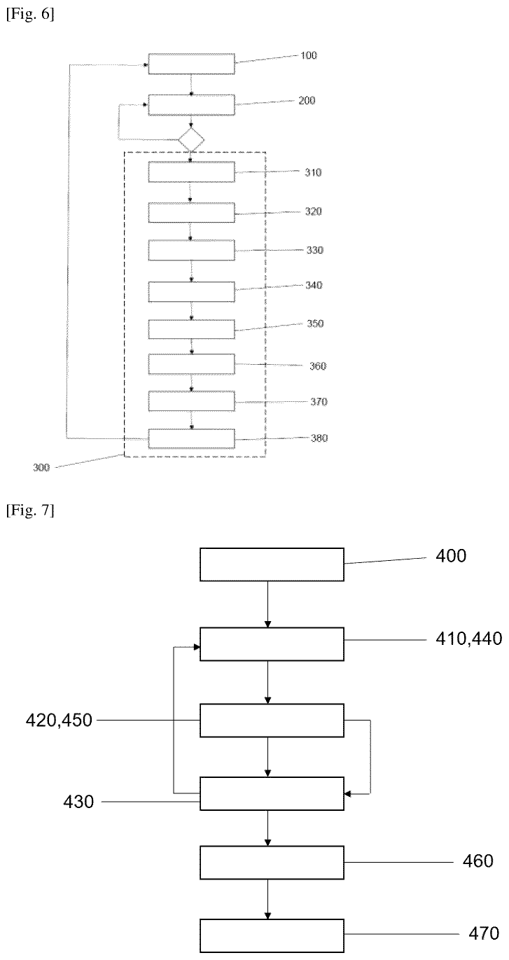

In one particular embodiment the method of controlling the installation 1 for shaping hollow bodies enables correction in a given process of any drift leading to variations of measured thicknesses compared to particular set point values of the treatment parameters of the treatment stations as a function of the measurements effected directly on the containers at the outlet of the shaping station, as depicted schematically in FIGS. 5 and 6. It will be seen that the thickness of the container is measured at two different heights at least by any appropriate means well known to the person skilled in the art, such as interferometer sensors for example.

The method therefore consists in measuring the thickness of the wall of said containers on extraction from the mold (step 100) at two different heights at least, then comparing (step 200) the thickness measurements with particular set point values for each height of the containers and, if the difference between the measurements of the thicknesses and the particular set point values is above a particular threshold, modifying (step 300) at least one of the control parameters, said modified control parameter or parameters being selected at least by calculating the theoretical effects of the variation of each parameter on the thickness and then selecting the parameter or parameters inducing the smallest difference between the measured values and the theoretical thickness values, and the foregoing steps are repeated until the difference between the measured thicknesses and the particular set point values is below said particular threshold.

To be more precise, referring to FIG. 6, the step (300) of modifying at least one of the control parameters comprises for example at least the following steps:
defining (310) for each parameter an optimum reference coefficient chosen from reference coefficients assigned to each thickness zone of the wall of the containers;
storing (320) the lower and upper limits and scales for each of said parameters;
calculating (330) an adjustment of each parameter as a function of said optimum reference coefficient defined beforehand;
calculating (340) the adjustments again if the calculated adjustments are not within said limits;
calculating (350) theoretical corrections for each thickness zone as a function of the calculated adjustments and the scales;
calculating (360) the theoretical thickness difference of the containers as a function of the theoretical corrections calculated for each thickness zone;
adding (370) said calculated theoretical differences for each parameter; and
selecting (380) at least one parameter having the lowest cumulative difference values.

Before the step of selecting at least one parameter, the method includes a step of defining a hierarchy of parameters according to said calculated theoretical differences. Said parameters are organized into a hierarchy in increasing order from the lowest cumulative difference to the highest cumulative difference.

Zero calculated theoretical corrections are preferably excluded and it is the absolute values of the calculated theoretical differences that are added.

The step of selecting the parameters is advantageously carried out after the calculation of a new mean value of the thicknesses for each zone and/or after the combination of the differences for each thickness zone has changed. In this way regulation in accordance with the invention enables correction of any differences in real time without being obliged to shut down the production installation and thereby maintaining the quality of the containers produced. A new mean value of the thicknesses for each zone is calculated at a predetermined frequency. For example the new mean value of the thicknesses for each zone is calculated every m bottles extracted from the mold for which the thickness has been measured, m being an integer between 30 and 80. For example, m is equal to 50. However, it is obvious that without departing from the scope of the invention m could be any integer.

It will be seen that, if after n corrections of said selected parameter, n being a predetermined number greater than or equal to 1, the difference between the thickness measurements and the particular set point values is above a particular threshold, then a new parameter is selected. Said selected new parameter i+1 corresponds to a hierarchical parameter i+1.

Furthermore, the optimum reference coefficients assigned to each zone of thickness of the wall of the containers are advantageously variable and calculated on each modification of a parameter. Said calculation of the optimum reference coefficient assigned to each zone of thickness of the wall of the containers is based on calculating the real effect of the adjustment on each zone of thickness of the wall of the containers.

Said calculation preferably includes at least one of the following steps:
calculating an offset of the blow-molding and/or heating parameter by multiplying said initial coefficient by the thickness drift;
determining the new coefficient as a function of the offset applied to the parameter and the measured real effect on the material distribution in each thickness zone.

It will be seen that such variable optimum reference coefficients enable customization of those coefficients as a function of the environment, the machine, the resin of the hollow bodies, etc.

Said parameter is a parameter of the heating unit such as the heating power at a particular height of the hollow body and/or the power of the ventilation for evacuating some of the heat in the heating unit and/or the preferred heating temperature profile and/or said parameter is a parameter of the shaping unit such as the value of the pre-blowing pressure and/or the start time of pre-blowing and/or the pre-blowing flowrate and/or the speed of the stretching rod and/or the blow-molding pressure.

In order to adapt the regulation method according to the invention to suit each process, the method advantageously includes a preliminary calibration step that includes the following steps; see FIG. 7. By “process” is meant the process of producing a particular type of container from a particular type of body and/or a particular type of resin.

Said calibration step comprises a first step (400) of producing containers on the basis of first control parameters for producing conform containers followed by a step (410) of measuring the thickness of the wall of said containers on extraction from the mold at two different heights at least corresponding to the production of containers on the basis of said first control parameters, said thickness measurement corresponding to a reference thickness that is stored in a memory unit in a step (420).

In a step (430) each control parameter is then modified. The control parameter is advantageously modified on the basis of a predetermined correction coefficient associated with said control parameter. This modification of each control parameter is effected by modifying the control parameters one by one on the basis of a predetermined correction coefficient associated with said control parameter. Alternatively, each control parameter is modified simultaneously with at least one other control parameter.

Furthermore, each control parameter is preferably modified in accordance with a predetermined incremental or decremental value.

After each modification of a control parameter the thickness of the wall of said containers is measured on extraction from the mold at two different heights at least in a step (440) and the thicknesses of the wall of said containers on extraction from the mold are stored (step (450)) for each control parameter modified in said memory unit.

In a step (460) said stored measured thicknesses are compared with said reference thickness or with a theoretical thickness, the theoretical thickness being the thickness that would have been obtained after modification of the parameter, preferably in accordance with predetermined correction coefficients, and finally, in a step (470), there is or are selected the control parameter or parameters that procure the thickness variation corresponding to the required thickness of the wall of the container or the predetermined correction coefficients associated with the control parameters are modified so that the measured thicknesses after modification of the control parameter or parameters correspond to the theoretical thicknesses that would have been obtained with the foregoing predetermined coefficients.

It is clear that for each process on first starting up production in the container shaping installation is started with a validated specific process after which each parameter of the process is slightly modified automatically and the resulting thicknesses are stored. It is therefore possible to customize the control algorithm for each process and, in the event of deviation of one or more thicknesses, the algorithm could therefore choose the optimum parameter or parameters to be modified and the values of the correction coefficients associated with each control parameter to return to the thicknesses in the specifications of the container production method.

In a variant of the method according to the invention said calibration step comprises a first step (400) of producing containers on the basis of first control parameters to produce conform containers followed by a step (410) of measuring the thickness of the wall of said containers on extraction from the mold at two different heights at least corresponding to the production of containers on the basis of said first control parameters, said thickness measurement corresponding to a reference thickness that is stored in a memory unit in a step (420).

Then, in a step (430) each control parameter is modified. In this variant the modification is not carried out as previously on the basis of a correction coefficient but empirically. Furthermore, each control parameter can be modified simultaneously with at least one other control parameter.

Furthermore, each control parameter is preferably modified on the basis of a predetermined incremental or decremental value.

After each modification of a control parameter the thickness of the wall of said containers is measured on extraction from the mold at two different heights at least in a step (440) and the thicknesses of the wall of said containers on extraction from the mold are stored (step (450)) for each control parameter modified in said memory unit.

Then, in a step (460), said stored measured thicknesses are compared with the thicknesses obtained without modification of the parameter or parameters and finally, in a step (470), a correction coefficient is determined for each control parameter for a thickness at a particular height, said correction coefficient procuring the thickness variation corresponding to the required thickness of the wall of the container at the particular height.

Thus, after the preliminary calibration step the regulation method according to the invention as described above includes at least the following steps:
measuring the thickness of the wall of said containers on extraction from the mold, at two different heights at least;
comparing the measurements of the thicknesses with particular set point values for each height of the containers;
if the difference of the measurements of the thicknesses from the particular set point values is above a particular threshold, modifying at least one of the control parameters, the or said modified control parameter(s) and the associated correction coefficients being selected from at least one of the control parameters procuring the variation of thickness of the wall of the containers most pertinent vis-à-vis the thickness difference measured of the wall of the containers during the calibration step and/or by calculating the theoretical effects of the variation for each parameter on the thicknesses, said theoretical effects of the variation for each parameter defining a theoretical thickness;
selecting the parameter or parameters inducing the smallest difference between the measured thickness values and the theoretical thickness values.

The foregoing steps are repeated until the differences of the measurements of the thicknesses from the particular set point values are below said particular threshold.

It will be seen that by “the most relevant variation of thickness of the wall of the containers” means the thickness variation corresponding to the required thickness of the wall of the container.

Furthermore, the first step of modification of at least one of the control parameters comprises at least the following steps of defining for each parameter an optimum reference coefficient chosen from the reference coefficients assigned to each thickness zone of the wall of the containers: defining for each parameter an optimum reference coefficient chosen from reference coefficients assigned to each thickness zone of the wall of the containers; storing the lower and upper limits and scales for each of said parameters; calculating an adjustment of each parameter as a function of said optimum reference coefficient defined beforehand; calculating theoretical corrections for each thickness zone as a function of the calculated adjustments and the scales; calculating the theoretical thickness difference of the containers as a function of the theoretical corrections calculated for each thickness zone; adding said calculated theoretical differences for each parameter; and selecting at least one parameter having the lowest cumulative difference values.

Furthermore, before the step of selecting at least one parameter the method includes a step of organizing the parameters into a hierarchy as a function of said calculated theoretical differences. Said parameters are therefore organized in a hierarchy in increasing order from the lowest cumulative difference value to the highest cumulative difference value.

After the step of calculating the adjustments and before the step of calculating the theoretical corrections, the method according to the invention preferably includes an additional step of recalculating the adjustments if the calculated adjustments are not within said limits.

Obviously, zero calculated theoretical corrections are excluded and it is the absolute values of the calculated theoretical differences that are added.

Furthermore, the step of selecting the parameter is preferably carried out after calculating a new mean value of the thicknesses for each zone and/or after the combination of the differences for each thickness zone has changed.

Said new mean value of the thicknesses for each zone is calculated at a predetermined frequency.

The method according to the invention advantageously includes a step of modification of the predetermined correction coefficients of the algorithm so that the measured thicknesses after modification of the control parameter or parameters correspond to the theoretical thicknesses that would have been obtained with the foregoing predetermined coefficients.

The regulation method and the calibration steps of said method take the form of an algorithm, i.e. a computer program product comprising a sequence of instructions that, when the program is executed by a computer, causes the latter to implement the steps of the method according to the invention, the computer program being stored on a medium such as a memory for example.

It goes without saying that after the calibration step in accordance with the invention described above, without departing from the scope of the invention, any type of production method based on different so-called control parameters such as the heating temperature of the hollow bodies in the oven, the blow-molding pressure in the mold and/or the pre-blowing pressure and/or the pre-blowing flowrate and/or the speed of the stretching rod for example could be used.

Finally, it should be understood that the examples that have just been described are merely particular illustrations that are in no case limiting on the fields of application of the invention.

We claim:

1. A method for producing thermoplastic material containers by blow-molding or stretch-blow-molding a hollow body heated beforehand in an oven and then disposed in a mold consisting of two half-molds delimiting a molding cavity, said hollow body being blow-molded in the mold, steps of heating the hollow bodies, pre-blowing, and blow-molding being controlled by a control unit controlling control parameters, the method comprising:
a preliminary calibration step, the preliminary calibration step comprising at least the following steps:
i) producing containers on the basis of first control parameters to produce conform containers, wherein the first control parameters comprise at least one of a heating temperature of the hollow bodies in the oven, a blowing pressure in the mold, a pre-blowing pressure, a pre-blowing flowrate, and a speed of a stretching rod;
ii) measuring a thickness of a wall of said containers on extraction from the mold at two different heights corresponding at least to the production of the containers, said measurement of the thickness corresponding to a reference thickness;
iii) storing said reference thickness in a memory unit;
iv) modifying at least one control parameter of the first control parameters;
v) measuring the thickness of the wall of said containers on extraction from the mold at two different heights at least after modification of said at least one control parameter;
vi) storing the thicknesses of the wall of said containers on extraction from the mold for each modified control parameter in said memory unit;
vii) comparing said stored measured thicknesses with the thicknesses obtained without modification of the at least one control parameter;
viii) determining a correction coefficient for a thickness at a particular height for each parameter, said correction coefficient procuring the thickness variation corresponding to the required thickness of the wall of the container at the particular height.

2. The method as claimed in claim 1, wherein:
the modifying at least one control parameter at step iv) is based on a predetermined correction coefficient associated with said control parameter;
the comparing said stored measured thicknesses at step vii) is compared with theoretical thicknesses that would have been obtained after modification of the one at least one control parameter in accordance with the predetermined correction coefficient; and
modifying the predetermined correction coefficients so that the thicknesses measured after modification of the control parameter or parameters correspond to the theoretical thicknesses that would have been obtained with the foregoing predetermined coefficients.

3. The method as claimed in claim 2, wherein after the preliminary calibration step, the method includes at least the following:
a) measuring the thickness of the wall of said containers on extraction from the mold at at least two different heights;
b) comparing the measurements of the thicknesses with particular set point values for each height of the containers;
c) if a difference of the measurements of the thicknesses from the particular set point values is above a particular threshold modifying at least one of the control parameters, the at least one control parameter and the associated predetermined correction coefficient is selected from at least one of the control parameters procuring the variation of thickness of the wall of the containers most pertinent compared with the thickness difference measured of the wall of the containers during the calibration step and/or by calculating theoretical effects of the variation for each parameter on the thicknesses, said theoretical effects defining the theoretical thickness,
then selecting the at least one parameter that induces a smallest difference between the measured thickness values and the theoretical thickness values;
d) repeating steps a) to c) until the differences of the measurements of the thicknesses from the particular set point values are below said particular threshold.

4. The method as claimed in claim 3, wherein step c) comprises at least the following steps:
defining for each parameter an optimum reference coefficient chosen from reference coefficients assigned to each thickness zone of the wall of the containers;
storing lower and upper limits and scales for each of said control parameters;
calculating an adjustment of each control parameter as a function of said optimum reference coefficient defined beforehand;
calculating theoretical corrections for each thickness zone as a function of the calculated adjustments and the scales;
calculating the theoretical thickness difference of the containers as a function of the theoretical corrections calculated for each thickness zone;
adding said calculated theoretical differences for each control parameter; and
selecting at least one control parameter having a lowest cumulative difference values.

5. The method as claimed in claim 4, wherein before the step of selecting at least one parameter, the method includes a step of organizing the control parameters into a hierarchy as a function of said calculated theoretical differences.

6. The method as claimed in claim 5, wherein said control parameters are organized into the hierarchy in increasing order from the lowest cumulative difference value to a highest cumulative difference value.

7. The method as claimed in claim 4, wherein after the step of calculating the adjustments and before the step of calculating the theoretical corrections, the method includes an additional step of recalculating the adjustments if the calculated adjustments are not within said upper and lower limits.

8. The method as claimed in claim 4, wherein zero calculated theoretical corrections are excluded.

9. The method as claimed in claim 4, wherein absolute values of the calculated theoretical differences are added.

10. The method as claimed in claim 4, wherein the step of selecting the parameter is carried out after calculating a new mean value of the thicknesses for each zone if the combination of the differences for each thickness zone has changed.

11. The method as claimed in claim 10, wherein a new mean value of the thicknesses for each zone is calculated at a predetermined frequency.

12. The method as claimed in claim 4, the method further comprising a step of modifying the predetermined correction coefficients so that the thicknesses measured after modification of the control parameter or parameters correspond to the theoretical thicknesses that would have been obtained using the foregoing predetermined coefficients.

13. The method as claimed in claim 1, wherein during said preliminary calibration step, each of the control parameters are modified one by one.

14. The method as claimed in in claim 1, wherein during said preliminary calibration step each control parameter is modified simultaneously with at least one other control parameter.

15. The method as claimed in in claim 1, wherein during said preliminary calibration step each control parameter is modified by a predetermined incremental or decremental value.

16. A data processing device comprising means for executing the steps of a method for producing thermoplastic material containers by blow-molding or stretch-blow-molding a hollow body heated beforehand in an oven and then disposed in a mold consisting of two half-molds delimiting a molding cavity, said hollow body being blow-molded in the mold, steps of heating the hollow bodies, pre-blowing, and blow-molding being controlled by a control unit controlling control parameters, the method comprising:
a preliminary calibration step, the preliminary calibration step comprising at least the following steps:
i) producing containers on the basis of first control parameters to produce conform containers, wherein the first control parameters comprise at least one of a heating temperature of the hollow bodies in the oven, a blowing pressure in the mold, a pre-blowing pressure, a pre-blowing flowrate, and a speed of a stretching rod;
ii) measuring a thickness of a wall of said containers on extraction from the mold at two different heights corresponding at least to the production of the containers, said measurement of the thickness corresponding to a reference thickness;
iii) storing said reference thickness in a memory unit;
iv) modifying at least one control parameter of the first control parameters;
v) measuring the thickness of the wall of said containers on extraction from the mold at two different heights at least after modification of said at least one control parameter;
vi) storing the thicknesses of the wall of said containers on extraction from the mold for each modified control parameter in said memory unit;
vii) comparing said stored measured thicknesses with the thicknesses obtained without modification of the at least one control parameter;
viii) determining a correction coefficient for a thickness at a particular height for each parameter, said correction coefficient procuring the thickness variation corresponding to the required thickness of the wall of the container at the particular height.

17. A computer-readable storage medium containing instructions which, when the instructions are executed by a computer, cause the computer to execute the steps of a method for producing thermoplastic material containers by blow-molding or stretch-blow-molding a hollow body heated beforehand in an oven and then disposed in a mold consisting of two half-molds delimiting a molding cavity, said hollow body being blow-molded in the mold, steps of heating the hollow bodies, pre-blowing, and blow-molding being controlled by a control unit controlling control parameters, the method comprising:
a preliminary calibration step, the preliminary calibration step comprising at least the following steps:
i) producing containers on the basis of first control parameters to produce conform containers, wherein the first control parameters comprise at least one of a heating temperature of the hollow bodies in the oven, a blowing pressure in the mold, a pre-blowing pressure, a pre-blowing flowrate, and a speed of a stretching rod;
ii) measuring a thickness of a wall of said containers on extraction from the mold at two different heights corresponding at least to the production of the containers, said measurement of the thickness corresponding to a reference thickness;
iii) storing said reference thickness in a memory unit;
iv) modifying at least one control parameter of the first control parameters;
v) measuring the thickness of the wall of said containers on extraction from the mold at two different heights at least after modification of said at least one control parameter;
vi) storing the thicknesses of the wall of said containers on extraction from the mold for each modified control parameter in said memory unit;
vii) comparing said stored measured thicknesses with the thicknesses obtained without modification of the at least one control parameter;
viii) determining a correction coefficient for a thickness at a particular height for each parameter, said correction coefficient procuring the thickness variation corresponding to the required thickness of the wall of the container at the particular height.
